(19) United States
(12) Patent Application Publication
(10) Pub. No.: US 2022/0063446 A1
(43) Pub. Date: Mar. 3, 2022

(54) Unattended Occupant Alarm Assembly

(71) Applicant: Larry Lewis, Decatur, IL (US)

(72) Inventor: Larry Lewis, Decatur, IL (US)

(21) Appl. No.: 17/010,943

(22) Filed: Sep. 3, 2020

(51) Int. Cl. B60N 2/00; B60N 2/26; B60Q 3/70; B60R 16/03; G01G 19/414; G01G 19/52

(52) U.S. Cl. CPC B60N 2/002; B60N 2/26; G01G 19/52; B60R 16/03; G01G 19/4142; B60Q 3/70

(57) ABSTRACT

An unattended occupant alarm assembly for inhibiting an occupant from being left unattended in a vehicle includes a triggering unit that is positioned on a car seat. In this way the triggering unit can be engaged by an occupant when the occupant sits in the car seat. A display unit is positioned within the vehicle such that the display unit is visible to the driver. The display unit displays alert indicia comprising the words “baby safe” when the display unit is turned on. The display unit is in communication with the trigger unit and the display unit is turned on when the triggering unit is engaged by the occupant. In this way the display unit inhibits the driver from leaving the occupant unattended.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to alarm devices and more particularly pertains to a new alarm device for inhibiting an occupant from being left unattended in a vehicle.

### (2) Description of Related Art Including Information Disclosed Under 37 CFR 1.97 and 1.98

The prior art relates to alarm devices including a variety of occupant alarms that include a weight sensor and an audible alarm. Additionally, the prior art discloses a variety of occupant alarms that are integrated into a child car seat and include a cigarette lighter adapter for a power supply. The prior art discloses an occupant alarm that includes pressure sensors positioned in a back seat of a vehicle along with an audible alarm and a visible alarm.

### BRIEF SUMMARY OF THE INVENTION

An embodiment of the disclosure meets the needs presented above by generally comprising a triggering unit that is positioned on a car seat. In this way the triggering unit can be engaged by an occupant when the occupant sits in the car seat. A display unit is positioned within the vehicle such that the display unit is visible to the driver. The display unit displays alert indicia comprising the words “baby safe” when the display unit is turned on. The display unit is in communication with the trigger unit and the display unit is turned on when the triggering unit is engaged by the occupant. In this way the display unit inhibits the driver from leaving the occupant unattended.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an unattended occupant alarm assembly according to an embodiment of the disclosure.

FIG. 2 is a perspective phantom view of an embodiment of the disclosure.

FIG. 3 is a back view of an embodiment of the disclosure.

FIG. 4 is a top perspective in-use view of an embodiment of the disclosure.

FIG. 5 is an interior perspective in-use view of an embodiment of the disclosure.

### DETAILED DESCRIPTION OF THE INVENTION

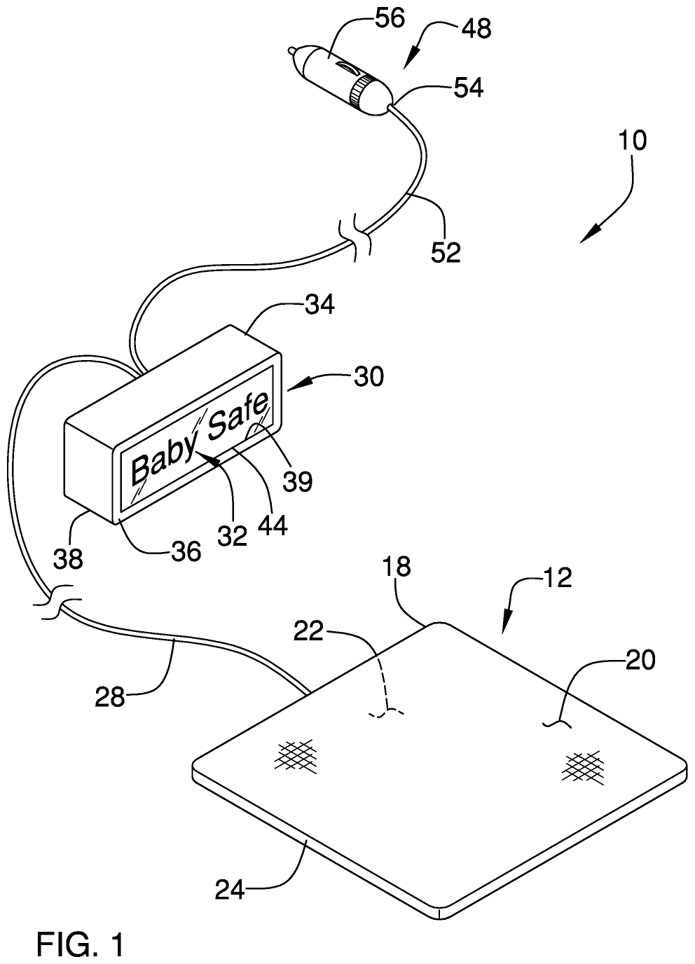

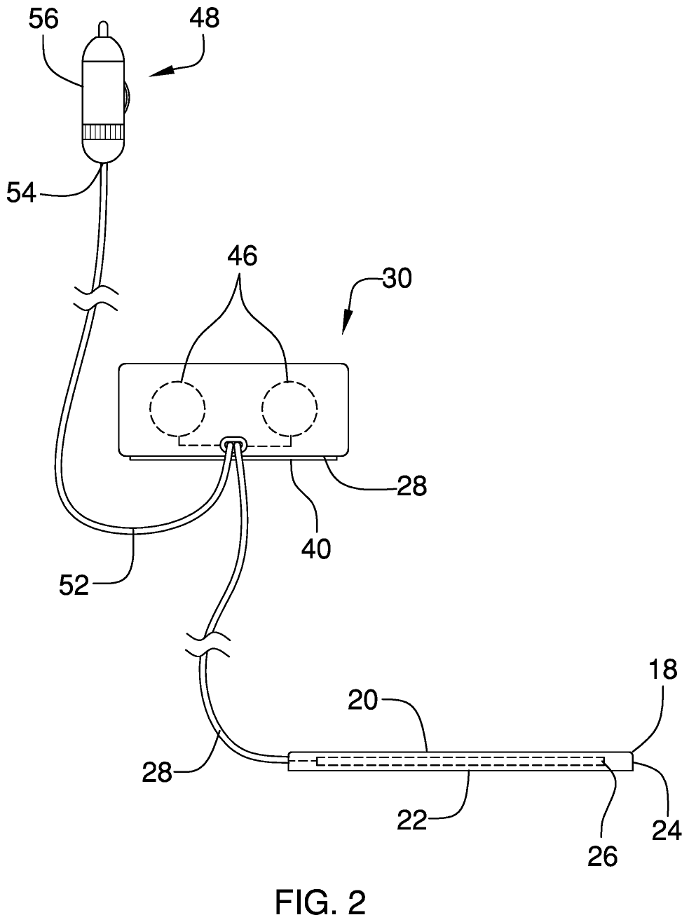

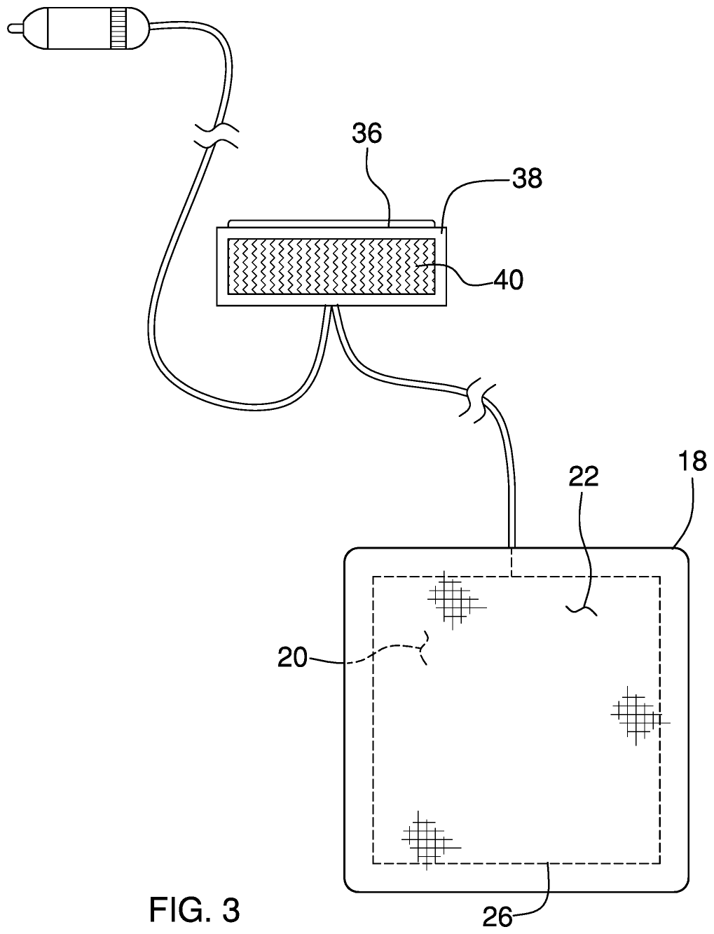

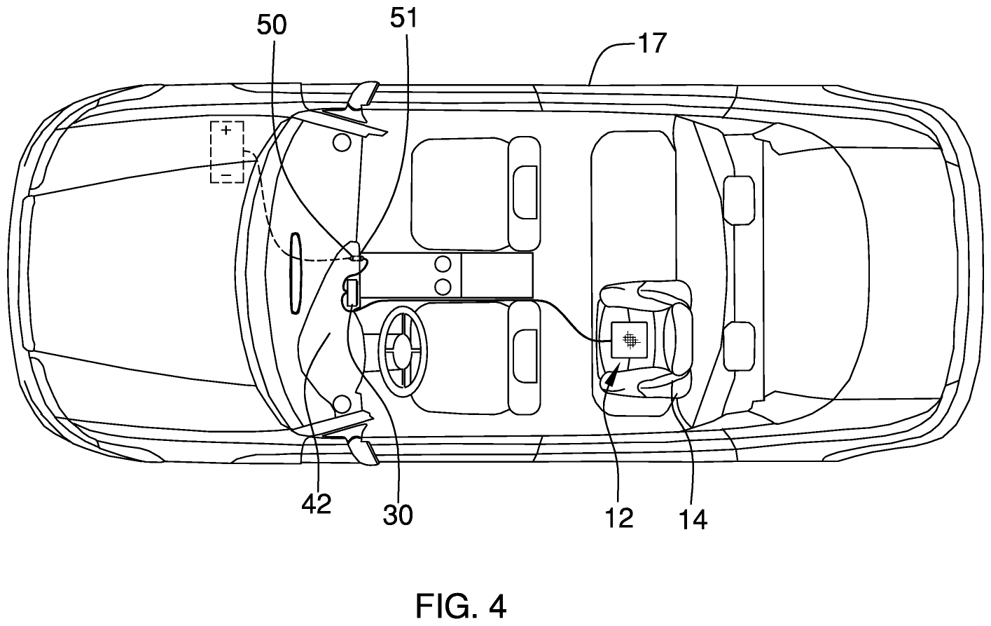

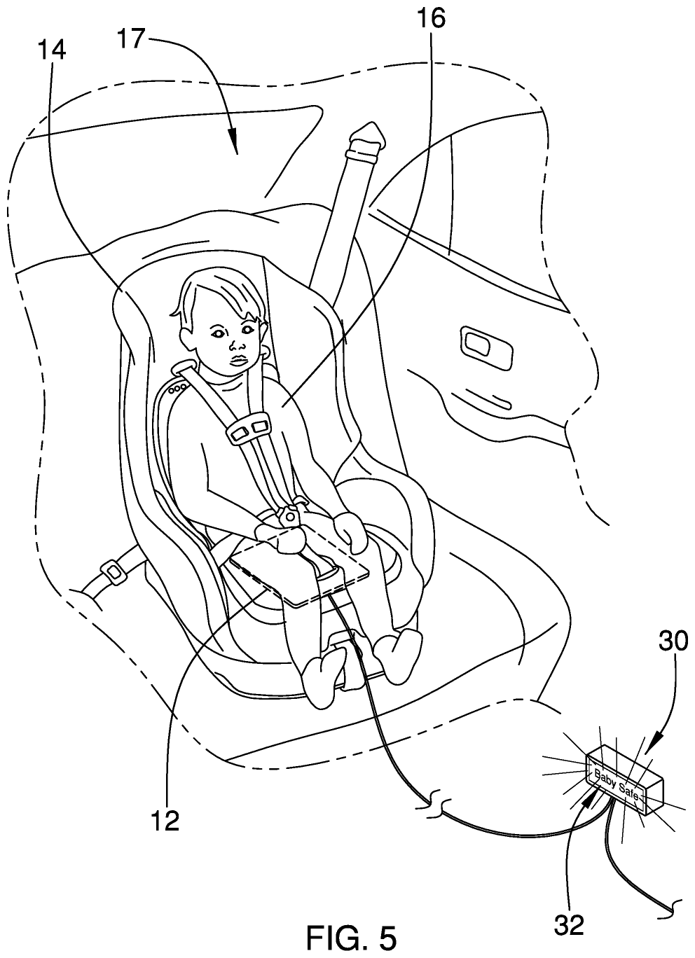

With reference now to the drawings, and in particular to FIGS. 1 through 5 thereof, a new alarm device embodying the principles and concepts of an embodiment of the disclosure and generally designated by the reference numeral 10 will be described.

As best illustrated in FIGS. 1 through 5, the unattended occupant alarm assembly 10 generally comprises a triggering unit 12 that is positioned on a car seat 14. In this way the triggering unit 12 is engaged by an occupant 16 when the occupant 16 sits in the car seat 14. The car seat 14 may be a child car seat that is positioned in a vehicle 17, such as a passenger vehicle or other type of motorized vehicle. Additionally, the occupant 16 may be a child that is seated in the child seat.

The triggering unit 12 comprises a pad 18 that has a top surface 20, a bottom surface 22 and a perimeter edge 24 extending therebetween. The bottom surface 22 is positioned against the car seat 14 and the occupant 16 sits on the top surface 20. The pad 18 is comprised of a resiliently compressible material such that the pad 18 is compressed by the weight of the occupant 16. A weight sensor 26 is positioned between the top surface 20 and the bottom surface 22 to sense weight of the occupant 16 when the occupant 16 sits on the pad 18. The weight sensor 26 may be an electronic weight sensor or the like that has a triggering threshold of approximately 2.5 kg. A trigger conductor 28 is coupled to and extends away from the perimeter edge 24 of the pad 18, and the trigger conductor 28 is electrically coupled to the weight sensor 26.

A display unit 30 is provided and the display unit 30 is positioned within the vehicle 17 such that the display unit 30 is visible to the driver. The display unit 30 displays alert indicia 32 comprising the words “baby safe” when the display unit 30 is turned on. The display unit 30 is in communication with the triggering unit 12 and the display unit 30 is turned on when the triggering unit 12 is engaged by the occupant 16. In this way the display unit 30 alerts the driver that the occupant 16 is seated thereby inhibiting the driver from leaving the occupant 16 unattended.

The display unit 30 comprises a housing 34 that has a forward wall 36 and a bottom wall 38. The housing 34 is positioned within the vehicle 17 such that the housing 34 is visible to the driver. The forward wall 36 has an opening 39 extending into an interior of the housing 34. A mating member 40 is coupled to the bottom wall 38 and the mating member 40 releasably engages a support structure 42 in the vehicle 17 to retain the housing 34 in a conspicuous location in the vehicle 17. The mating member 40 may comprise a hook and loop fastener, an adhesive strip or other type of releasable mating member.

A lens 44 is coupled to the forward wall 36 and the lens 44 is positioned to cover the opening 39 in the forward wall 36. Moreover, the lens 44 is comprised of a translucent material to pass light therethrough and the alert indicia 32 are printed across the lens 44. The alert indicia 32 have a contrasting color with respect to the color of the lens 44 such that the alert indicia 32 are highly visible to the driver. The display unit 30 includes a light emitter 46 is positioned in the housing 34 to emit light outwardly therefrom. The light emitter 46 is aligned with the opening 39 in the forward wall 36 thereby illuminating the alert indicia 32. In this way the light emitter 46 can visually alert the driver that the occupant 16 is seated. The light emitter 46 is electrically coupled to the trigger conductor 28 such that the light emitter 46 is turned on when the weight sensor 26 senses weight.

A power supply 48 is coupled to the display unit 30 and the power supply 48 is placed in electrical communication with a power source 50 comprising a power port 51 in the vehicle 17. The power port 51 may be a cigarette lighter or similar 12.0 volt power supply commonly found in motorized vehicles. The power supply 48 is electrically coupled to the display unit 30. The power supply 48 comprises a power cord 52 that is coupled to and extends away from the housing 34. The power cord 52 has a distal end 54 with respect to the housing 34 and the power cord 52 is electrically coupled to the light emitter 46. A plug 56 is electrically coupled to the distal end 54 of the power cord 52. The plug 56 engages the power port 51 such that the power cord 52 is electrically coupled to an electrical system of the vehicle 17.

In use, the housing 34 is mounted in a conspicuous location in the vehicle 17 and the pad 18 is positioned on the car seat 14. The light emitter 46 is turned on when the weight sensor 26 senses the weight of the occupant 16 thereby visually alerting the driver that the occupant 16 is seated. Moreover, the light emitter 46 is turned off when the weight sensor 26 does not sense with weight of the occupant 16. In this way the light emitter 46 inhibits the driver from leaving the occupant 16 unattended in the vehicle 17. Additionally, the triggering unit 12 and the display unit 30 can be employed in almost any type of vehicle 17 for universal application.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An unattended occupant alarm assembly for alerting a driver that a child is seated in a vehicle to inhibit the driver from leaving the child unattended, said assembly comprising:
a triggering unit being positioned on a car seat wherein said triggering unit is configured to be engaged by an occupant when the occupant sits in the car seat; and
a display unit being positioned within the vehicle wherein said display unit is configured to be visible to the driver, said display unit displaying alert indicia comprising the words “baby safe” when said display unit is turned on, said display unit being in communication with said trigger unit, said display unit being turned on when said triggering unit is engaged by the occupant wherein said display unit is configured to alert the driver that the occupant is seated thereby inhibiting the driver from leaving the occupant unattended.

2. The assembly according to claim 1, wherein said triggering unit comprises a pad having a top surface, a bottom surface and a perimeter edge extending therebetween, said bottom surface being positioned against the car seat wherein said top surface is configured to have the occupant sit therein, said pad being comprised of a resiliently compressible material wherein said pad is configured to be compressed by the weight of the occupant.

3. The assembly according to claim 2, wherein said triggering unit includes a weight sensor being positioned between said top surface and said bottom surface wherein said weight sensor is configured to sense weight of the occupant when the occupant sits on said pad.

4. The assembly according to claim 3, wherein said trigger unit includes a trigger conductor being coupled to and extending away from said perimeter edge of said pad, said trigger conductor being electrically coupled to said weight sensor.

5. The assembly according to claim 1, wherein said display unit comprises a housing having a forward wall and a bottom wall, said housing being positioned within the vehicle wherein said housing is configured to be visible to the driver, said forward wall having an opening extending into an interior of said housing.

6. The assembly according to claim 5, wherein said display unit includes a mating member being coupled to said bottom wall, said mating member releasably engaging a support structure in the vehicle wherein said mating member is configured to retain said housing in a conspicuous location in the vehicle.

7. The assembly according to claim 5, wherein said display unit includes a lens being coupled to said forward wall, said lens being positioned to cover said opening in said forward wall, said lens being comprised of a translucent material wherein said lens is configured to pass light therethrough, said alert indicia being printed across said lens, said alert indicia having a contrasting color with respect to the color of said lens wherein said alert indicia is configured to be highly visible to the driver.

8. The assembly according to claim 7, wherein:
said trigger unit includes a trigger conductor and a weight sensor; and
said display unit includes a light emitter being positioned in said housing wherein said light emitter is configured to emit light outwardly therefrom, said light emitter being aligned with said opening in said forward wall thereby illuminating said alert indicia wherein said light emitter is configured to visually alert the driver that the occupant is seated, said light emitter being electrically coupled to said trigger conductor such that said light emitter is turned on when said weight sensor senses weight.

9. The assembly according to claim 8, further comprising a power supply being coupled to said display unit, said power supply being placed in electrical communication with a power source comprising a power port in the vehicle, said power supply being electrically coupled to said display unit, said power supply comprising:
a power cord being coupled to and extending away from said housing, said power cord having a distal end with respect to said housing, said power cord being electrically coupled to said light emitter; and
a plug being electrically coupled to said power cord, said plug engaging the power port wherein said power cord is configured to be electrically coupled to an electrical system of the vehicle.

10. An unattended occupant alarm assembly for alerting a driver that a child is seated in a vehicle to inhibit the driver from leaving the child unattended, said assembly comprising:
a triggering unit being positioned on a car seat wherein said triggering unit is configured to be engaged by an occupant when the occupant sits in the car seat, said triggering unit comprising:
a pad having a top surface, a bottom surface and a perimeter edge extending therebetween, said bottom surface being positioned against the car seat wherein said top surface is configured to have the occupant sit therein, said pad being comprised of a resiliently compressible material wherein said pad is configured to be compressed by the weight of the occupant;
a weight sensor being positioned between said top surface and said bottom surface wherein said weight sensor is configured to sense weight of the occupant when the occupant sits on said pad; and
a trigger conductor being coupled to and extending away from said perimeter edge of said pad, said trigger conductor being electrically coupled to said weight sensor;
a display unit being positioned within the vehicle wherein said display unit is configured to be visible to the driver, said display unit displaying alert indicia comprising the words “baby safe” when said display unit is turned on, said display unit being in communication with said trigger unit, said display unit being turned on when said triggering unit is engaged by the occupant wherein said display unit is configured to alert the driver that the occupant is seated thereby inhibiting the driver from leaving the occupant unattended, said display unit comprising:
a housing having a forward wall and a bottom wall, said housing being positioned within the vehicle wherein said housing is configured to be visible to the driver, said forward wall having an opening extending into an interior of said housing;
a mating member being coupled to said bottom wall, said mating member releasably engaging a support structure in the vehicle wherein said mating member is configured to retain said housing in a conspicuous location in the vehicle;
a lens being coupled to said forward wall, said lens being positioned to cover said opening in said forward wall, said lens being comprised of a translucent material wherein said lens is configured to pass light therethrough, said alert indicia being printed across said lens, said alert indicia having a contrasting color with respect to the color of said lens wherein said alert indicia is configured to be highly visible to the driver; and
a light emitter being positioned in said housing wherein said light emitter is configured to emit light outwardly therefrom, said light emitter being aligned with said opening in said forward wall thereby illuminating said alert indicia wherein said light emitter is configured to visually alert the driver that the occupant is seated, said light emitter being electrically coupled to said trigger conductor such that said light emitter is turned on when said weight sensor senses weight; and
a power supply being coupled to said display unit, said power supply being placed in electrical communication with a power source comprising a power port in the vehicle, said power supply being electrically coupled to said display unit, said power supply comprising:
a power cord being coupled to and extending away from said housing, said power cord having a distal end with respect to said housing, said power cord being electrically coupled to said light emitter; and
a plug being electrically coupled to said power cord, said plug engaging the power port wherein said power cord is configured to be electrically coupled to an electrical system of the vehicle.
